(19) United States
(12) Patent Application Publication
(10) Pub. No.: US 2024/0423237 A1
(43) Pub. Date: Dec. 26, 2024

(54) MEAT ANALOGUE PRODUCTS COMPRISING MODIFIED STARCH

(71) Applicant: Cargill, Incorporated, Wayzata, MN (US)

(72) Inventors: Wesley Boone Griffin, Goddard, KS (US); Melissa Ann Machen, Union, MO (US); Summer Steeples, Valley Center, KS (US)

(73) Assignee: Cargill, Incorporated, Wayzata, MN (US)

(21) Appl. No.: 18/689,965

(22) PCT Filed: Sep. 10, 2022
(86) PCT No.: PCT/US2022/076249

§ 371 Date: Mar. 7, 2024

Related U.S. Application Data
(60) Provisional application No. 63/242,535, filed on Sep. 10, 2021.

(51) Int. Cl. A23J 3/22; A23J 3/16; A23L 29/219; A23L 29/262

(52) U.S. Cl. CPC A23J 3/227; A23J 3/16; A23L 29/219; A23L 29/262

(57) ABSTRACT

In method of preparing a meat analogue product, vegetable oil; a modified starch selected from a starch octenylsuccinate, a hydroxypropyl distarch phosphate, and mixtures thereof; and methylcellulose in water to form a vegetable oil/starch/methylcellulose emulsion. The vegetable oil/starch/methylcellulose emulsion is mixed with a hydrated plant protein to form a meat analogue product comprising from 3 to 22 wt % vegetable oil. This cooked meat analogue product may be frozen to provide a frozen, cooked meat analogue product, which in turn may be reheated by the consumer.

### CROSS-REFERENCE TO RELATED APPLICATIONS

This application claims the benefit of U.S. Provisional Patent Application No. 63/242,535, filed 10 Sep. 2021, which is hereby incorporated by reference in its entirety.

### FIELD

The present invention relates to meat analogue products comprising modified starch.

### BACKGROUND

Consumers increasingly desire protein choices that are alternatives to animal meat protein for a variety of reasons. At the same time, many consumers enjoy the flavors and textures that are uniquely provided by meats obtained from animals. For this reason, a number of companies have striven to provide plant-based meat substitutes that replicate the experience of cooking and eating meat.

Examples of plant-based meat substitute products include the Impossible Burger from Impossible Foods, The Beyond Burger from Beyond Meat, and Ultimate Beefless Burger from Gardein. These and other products are discussed, for example, at https://www.healthline.com/nutrition/vegan-meat-substitutes#section4, which states that the Beyond Burger is made from pea protein, canola oil, coconut oil, potato starch and other ingredients.

U.S. Pat. No. 9,700,067 to Fraser et. al and assigned to Impossible Foods describes a ground beef-like food product comprising a heme-containing protein, plant proteins, and additional compounds, wherein cooking the ground beef-like food product results in the production of at least two volatile compounds which have a beef-associated aroma. Particular flavor precursors or compositions are described, including, for example, yeast extract, vegetable oil, corn oil, soybean oil, palm fruit oil, palm kernel oil, safflower oil, flaxseed oil, rice bran oil, cottonseed oil, olive oil, canola oil, sunflower oil, coconut oil, mango oil, or an algal oil. See, e.g., column 2, lines 55-59. Formulations of replica burgers comprising coconut oil are described in the Examples of this patent.

United States Patent Application Pub. No. 2013/0243932 describes meat products made by blending a starch, hydrocolloid, and an oil from a vegetable source. The resulting product is stated to be a product with reduced animal fat that maintains the sensory attributes of a full-fat product. Modified starches, including an nOSA starch, are described at paragraph [0018] of this application.

United States Patent Application Pub. No. 2010/0278994 describes preparing dairy products that include starch that has been modified by reaction with n-octenyl succinic anhydride (nOSA).

WO 2012075088 describes a meat substitute, such as vegetable protein, is blended with a starch, hydrocolloid, and an oil from a vegetable source. Modified starches, including an nOSA starch, are described at paragraph [0014] of this application. The products are manufactured as described in the Examples by first preparing a fat memetic from ingredients that are compiled and then heated with agitation. The fat memetic is then refrigerated for a minimum of 24 hours and ground, diced, grated, or shredded to desired size. This solid form fat memetic is added to a textured soy composition and formed into patties.

US 2012/0093994 describes analog meat compositions produced from vegetable protein and processes for producing the analog meat compositions are described. The compositions are produced with high moisture content, low vegetable protein content, carbohydrate, and, optionally, an edible lipid material and provides a product that simulates the fibrous structure of animal meat and has a desirable meat-like moisture, texture, mouthfeel, flavor and color.

### SUMMARY

Meat analogue products for purposes of the present discussion are food products that mimic meat but which contain no animal meat ingredients. Previous attempts at preparing meat analogue products often fall short of the desired organoleptic experience, because they lack one or more of the visual and textural characteristics of the animal meat it is intended to mimic. One can make a meat analogue product by use of a plant-based protein with added vegetable oil to try to make a meat analog with a representative protein/oil content, but the texture of such a product is lacking.

In particular, the cooking behavior, mouthfeel, moisture, and presentation of the desired protein/oil balance in meat analogue products is particularly challenging because vegetable-sourced oils are normally lost from the product during cooking. It additionally is challenging to achieve the desired consistency of the meat analogue product while using only non-animal-sourced components without incorporating a number of additives that present a long ingredient list with names that sound artificial and undesirable to the average consumer.

A particularly challenging type of meat analogue product to be prepared is one that is prepared and cooked at a first location, such as a food processing plant, and frozen for transport and storage until reheated later at a commercial establishment or by the home consumer. Products with this storage and reheating history are usually quite disappointing, because the vegetable-sourced oils that are initially incorporated in the product are normally lost from the product during the reheating step.

It has been found that excellent a meat analogue products may be prepared by mixing vegetable oil; a modified starch selected from a starch octenylsuccinate, a hydroxypropyl distarch phosphate, and mixtures thereof; and methylcellulose in water to form a vegetable oil/starch/methylcellulose emulsion, and mixing this this vegetable oil/starch/methylcellulose emulsion in liquid or semi-solid form with a hydrated plant protein to form a meat analogue product comprising from 3 to 22 wt % vegetable oil. In an aspect, a binder is also added with the with a hydrated plant protein. The resulting meat analogue products have been found to exhibit surprising organoleptic benefits. While not being bound by theory, it is believed that the vegetable oil and the modified starch interact with each other in a way that enhances oil retention and other physical properties in the meat analogue products after being cooked and especially after being reheated. In an aspect, has been found that the meat analog products as presently described are perceived by experienced food evaluators to mimic the organoleptic experience of eating a meat product comprising animal fat mouthfeel surprisingly well. Additionally, it has been found that the meat analog products as presently described are perceived by to mimic the experience of cooking (e.g., frying) a meat product comprising animal fat mouthfeel surprisingly well.

In an aspect, the formed meat analogue product is cooked for a suitable time and temperature to provide a cooked meat analogue product and refrigerated or frozen for reheating by the consumer. The cooked meat analogue products prepared in this manner afford a unique food product with exceptional convenience in final preparation by the customer, and excellent organoleptic properties to the consumer. In particular, the frozen cooked meat analogue product as described herein provides an excellent food product with long storage time and superior oil stability.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

As noted above, the first step in preparing a meat analogue product is to mix vegetable oil; a modified starch selected from a starch octenylsuccinate, a hydroxypropyl distarch phosphate, and mixtures thereof; and methylcellulose in water to form a vegetable oil/starch/methylcellulose emulsion.

In an aspect, the vegetable oil is selected from the group consisting of avocado, canola, coconut, cocoa, corn, cottonseed, flax, olive, palm, palm kernel, peanut, rapeseed, safflower, soya, and sunflower and mixtures thereof. In an aspect, the vegetable oil is selected from the group consisting of canola oil, coconut oil, and mixtures thereof. In an aspect, the vegetable oil is selected from unsaturated vegetable oils. In an aspect, the vegetable oil is selected from poly-unsaturated vegetable oils. In an aspect, the vegetable oil is selected from vegetable oils having a smoke point above 400 F. It has been found that vegetable oil is selected from saturated oils, such as coconut/cocoa oils exhibit superior mouthfeel and lubricity.

The starch is a modified starch selected from a starch octenylsuccinate, a hydroxypropyl distarch phosphate, and mixtures thereof.

In an aspect, the starch source of the modified starch is selected from the group consisting maize starch, potato starch, sweet potato starch, wheat starch, rice starch, tapioca starch, sorghum starch, sago starch, and mixtures thereof.

In an aspect, the starch is a hydroxypropyl distarch phosphate made from waxy maize, such as PolarTex 06732 from Cargill, Incorporated.

In an aspect, the starch is a n-OSA substituted dextrin made from waxy maize starch, such as EmCap 06376 from Cargill, Incorporated. In an aspect, the starch is an acid thinned n-OSA substituted dextrin made from waxy maize starch, such as EmCap 06375 from Cargill, Incorporated.

In an aspect, the starch is a n-OSA substituted and oxidized tapioca starch, such as C*DeliTex 75320 from Cargill, Incorporated. Examples of n-octenyl succinilated starches are disclosed in U.S. Pat. No. 6,235,894, the disclosure of which is incorporated herein by reference.

It has been found that incorporation of the modified starch in the meat analogue product as presently described provides a substantial benefit in processing, and additionally in mouthfeel of the final product. In an aspect, the meat analogue product as described herein provides a positive moisture perception in mouth, which is a positive attribute associated with meat.

It has been found that incorporation of methylcellulose in the meat analogue product as presently described provides a substantial benefit both in the product in its uncooked state and after the product is cooked. Methylcellulose has been found to exhibit excellent emulsifying performance in the raw product to provide superior product mixing, stabilization, and handling properties. Additionally, meat analogue products as presently described comprising methylcellulose have been found exhibit a superior, firm texture to the product during cooking and while the product is hot as compared to like products not comprising methylcellulose. While not being bound by theory, it is believed that methylcellulose exhibits at least partially thermo-reversible texture enhancing properties in the context of the present meat analogue product, so that the meat analog is much firmer when hot than when cold. Thus, the cold, uncooked meat analogue product has good consistency while being easy shape and otherwise handle. During and after cooking, the meat analogue product exhibits firm texture mimicking the texture of cooked meat products.

In an aspect, the methylcellulose is a food grade methylcellulose yielding a viscosity of from about 8000 to about 160,000 cP at 2% in water @20° C. In an aspect, the methylcellulose is a food grade methylcellulose having a viscosity of from about 37500 to about 100,000 cP at 2% in water @20° C. In an aspect, the methylcellulose is a food grade methylcellulose having a viscosity of from about 80000 to about 160,000 cP at 2% in water @20° C. In an aspect, the methylcellulose is a food grade methylcellulose having a methoxyl content of from about 25% to about 32%. Suitable methylcellulose products are commercially available, such as Dow Wellence Vege Form 183 or Shin Etsu Metolose MCE-100TS.

In an aspect, the emulsion is prepared by mixing the modified starch with the vegetable oil in a ratio of from about 1 to 12 parts modified starch for every 100 parts vegetable oil. In an aspect, the emulsion is prepared by mixing the modified starch with the vegetable oil in a ratio of from about 2 to 10 parts modified starch for every 100 parts vegetable oil. In an aspect, the emulsion is prepared by mixing the modified starch with the vegetable oil in a ratio of from about 2 to 8 parts modified starch for every 100 parts vegetable oil. In an aspect, the emulsion is prepared by mixing the modified starch with the vegetable oil in a ratio of from about 20 to 30 parts modified starch for every 100 parts vegetable oil. In an aspect, the emulsion is prepared by mixing the modified starch with the vegetable oil in a ratio of from about 26 to 30 parts modified starch for every 100 parts vegetable oil. In an aspect, the emulsion is prepared by mixing the modified starch with the vegetable oil in a ratio of from about 20 to 35 parts modified starch for every 100 parts vegetable oil.

In an aspect, the emulsion is prepared by mixing the methylcellulose with the vegetable oil in a ratio of from about 1 to 14 parts methylcellulose for every 100 parts vegetable oil. In an aspect, the emulsion is prepared by mixing the methylcellulose with the vegetable oil in a ratio of from about 2 to 12 parts methylcellulose for every 100 parts vegetable oil. In an aspect, the emulsion is prepared by mixing the methylcellulose with the vegetable oil in a ratio of from about 2 to 10 parts methylcellulose for every 100 parts vegetable oil. In an aspect, the emulsion is prepared by mixing the methylcellulose with the vegetable oil in a ratio of from about 18 to 22 parts methylcellulose for every 100 parts vegetable oil. In an aspect, the emulsion is prepared by mixing the methylcellulose with the vegetable oil in a ratio of from about 15 to 25 parts methylcellulose for every 100 parts vegetable oil.

Water is added to the vegetable oil, an n-octenylsuccinic anhydride modified starch, and methylcellulose in an amount sufficient to support an emulsion. In an aspect, the emulsion comprises water in an amount of from about 30 to about 70 wt % of the emulsion.

In an aspect, the emulsion comprises oil in an amount of from about 10 to about 50 wt % of the emulsion. In an aspect, the ratio of vegetable oil to water in the emulsion is from about 40 to about 70 parts oil for every 100 parts water. In an aspect, the ratio of vegetable oil to water in the emulsion is from about 50 to about 70 parts oil for every 100 parts water. In an aspect, the ratio of vegetable oil to water in the emulsion is from about 30 to about 65 parts oil for every 100 parts water. In an aspect, the ratio of vegetable oil to water in the emulsion is from about 40 to about 60 parts oil for every 100 parts water. In an aspect, the ratio of vegetable oil to water in the emulsion is from about 40 to about 50 parts oil for every 100 parts water.

In an aspect, the emulsion is prepared by first combining one or both of the methylcellulose and the n-octenylsuccinic anhydride modified starch with the vegetable oil, and then mixing these components before addition of water. Water is then added to this mixture, and the resulting composition is mixed under emulsifying conditions.

In an aspect, the emulsion is prepared by combining the methylcellulose and the n-octenylsuccinic anhydride modified starch and the vegetable oil with water, and the resulting composition is mixed under emulsifying conditions.

If necessary, the oil may be heated so that it is mixed from the liquid stage. In an aspect, the mixing takes place at a temperature of from about 60° F. to about 150° F. In an aspect, the mixing takes place at a temperature of from about 60° F. to about 125° F. In an aspect, the mixing takes place at a temperature of from about 60° F. to about 100° F. In an aspect, the mixing takes place at a temperature of from about 32° F. to about 60° F. In an aspect, the mixing takes place at a temperature of from about 32° F. to about 40° F.

Any suitable mixing apparatus may be used to prepare the emulsion, such as a blender.

In an aspect, after formation of the emulsion, the emulsion is cooled to or maintained at a temperature of from about 40° F. or less. In an aspect, after formation of the emulsion, the emulsion is cooled to or maintained at a temperature of from about 32° F. to about 40° F. In an aspect, after formation of the emulsion, the emulsion is frozen. In an aspect, after formation of the emulsion, the emulsion is cooled to or maintained at a temperature of from about −20° F. to about 32° F. In an aspect, after formation of the emulsion, the emulsion is cooled to or maintained at a temperature of from about −10° F. to about 10° F. In an aspect, after formation of the emulsion, the emulsion is cooled to or maintained at a temperature of from about −5° F. to about 5° F.

A hydrated plant protein for forming a meat analogue product is prepared by mixing a plant protein composition with water to form a hydrated plant protein composition. The plant protein is hydrated by mixing the plant protein composition with water in any appropriate vessel, such as a mixer or blender. In an aspect, water is mixed with the plant protein composition in a water:(protein composition) weight ratio of from about 2:1 to about 4:1. In an aspect, water is mixed with the plant protein composition in a water:(protein composition) weight ratio of about 3:1.

In an aspect, the plant protein used in the present process may be selected from one or more of alfalfa, algal, barley, bean, broad bean, chia, clover, pea, chickpea, cow pea, earth pea, sweet pea, pigeon pea, kidney bean, mung bean, navy bean, soy, legume, lentil, lupin, mesquite, cocoa, carob, nut, peanut, almond, potato, gluten, cereal, maize, rice, wheat, wheat gluten, sorghum, millet, oat, rye, triticale, buckwheat, fonio, quinoa, hemp, fungal, or seaweed protein. In an aspect, the plant protein used in the present process may be selected from soy or pea protein. In an aspect, the plant protein is selected from textured soy protein, textured pea protein, or mixtures thereof.

In an aspect, the plant protein composition comprises plant protein in the form of a protein concentrate. In an aspect, the plant protein composition comprises plant protein in the form of a protein isolate. In an aspect, the plant protein composition comprises plant protein in the form of a flour.

In an aspect, the hydrated plant protein composition comprises an additional ingredient selected from flavorant, colorant, preservative (i.e. an ingredient to prevent or retard micro growth and/or spoilage), fiber, and hydrocolloids (such as methylcellulose and starches).

In an aspect, the hydrated plant protein composition comprises flavor ingredients selected to mimic the flavor of beef. In an aspect, the hydrated plant protein composition comprises flavor ingredients selected to mimic the flavor of pork. In an aspect, the hydrated plant protein composition comprises flavor ingredients selected to mimic the flavor of chicken. In an aspect, the hydrated plant protein composition comprises flavor ingredients selected to mimic the flavor of turkey.

In an aspect, the meat analogue product contains non-meat ingredients that are provided in liquid form or small particle form, such as added binders, salt, seasoning and the like. In an aspect, the non-meat ingredients are provided in particle form of a particle size of 300 microns or less. In an aspect, the non-meat ingredients are provided in particle form of a particle size of 50 to 200 microns. In an aspect, the non-meat ingredients are provided in particle form of a particle size of 100 to 150 microns.

In an aspect, the meat analogue product contains non-meat, animal-sourced ingredients that are provided in liquid form or small particle form. In an aspect, the non-meat, animal-sourced ingredients are provided in particle form of a particle size of 300 microns or less. In an aspect, the non-meat, animal-sourced ingredients are provided in particle form of a particle size of 50 to 200 microns. In an aspect, the non-meat, animal-sourced ingredients are provided in particle form of a particle size of 100 to 150 microns. In an aspect, the meat analogue product contains non-meat, animal-sourced ingredients that are dairy ingredients (such as milk, butter, milk fat, whey proteins, buttermilk, and buttermilk powder) and egg ingredients, (such as egg yolk, egg white, albumin and mixtures thereof).

In an aspect, any of the desired added ingredients may be added to the dry plant protein composition, or to the hydration water or both.

Any suitable mixing apparatus may be used to prepare the hydrated plant protein composition. In an aspect, the mixing apparatus is a blender. In an aspect, the mixing apparatus uses an impeller such as a paddle blender.

In an aspect, the mixing apparatus is a food chopper. For purposes of the present description, a food chopper is a food cutter having a flat surface for receiving food to be cut, and one or more vertically movable cutting blades configured to effectively mix the hydrated plant protein composition.

In an aspect, the mixing apparatus is a bowl chopper. For purposes of the present description, a bowl chopper is a food cutter having a rotary bowl for receiving food to be cut, and one or more vertically oriented blades (also described as “knives” in the art) attached to a horizontally oriented rotary knife shaft. The rotary bowl rotates around a vertical axis, and the blades cut by rotation of the horizontally oriented rotary knife shaft. The blades are aligned relative to the internal wall or walls of the bowl such that they may chop and mix the food within the bowl. While the lateral position of the rotary knife shaft is substantially stationary, the bowl and the contents therein rotate relative to the blades whereby the contents are continuously moved against the blades as the bowl is rotating. In an aspect, the blades may be run in only a forward direction, or in an aspect run in both a forward direction and a reverse direction. Bowl choppers are commercially available, and are described, for example, in U.S. Pat. No. 5,996,917, the disclosure of which is incorporated herein by reference.

In an aspect, the mixing apparatus is a food processor. For purposes of the present description, a food processor is a food cutter having a food container for receiving food to be cut that is fitted with a hub configured to be coupled to a drive shaft of the food processor. One or more blades are rotatably coupled to the hub. In the case of the food processor, the blades are horizontally oriented, and the hub and drive shaft are generally vertically oriented. In an aspect, the blades may be run in only a forward direction, or in an aspect run in both a forward direction and a reverse direction. Food processors are commercially available, and are described, for example, in U.S. Pat. No. 7,054,348, the disclosure of which is incorporated herein by reference.

The thus prepared hydrated plant protein composition is mixed with the vegetable oil/starch/methylcellulose emulsion to form the meat analogue product. In an aspect, the vegetable oil/starch/methylcellulose emulsion is mixed in liquid or semi-solid form with a plant protein to form a meat analogue product comprising from 0.01 to 22 wt % vegetable oil. In an aspect, the vegetable oil/starch/methylcellulose emulsion is mixed in liquid or semi-solid form with a plant protein to form a meat analogue product comprising from 1 to 22 wt % vegetable oil. In an aspect, the vegetable oil/starch/methylcellulose emulsion is mixed in liquid or semi-solid form with a plant protein to form a meat analogue product comprising from 3 to 22 wt % vegetable oil. In an aspect, the vegetable oil/starch/methylcellulose emulsion is mixed in liquid or semi-solid form with a plant protein to form a meat analogue product comprising from 8 to 22 wt % vegetable oil. In an aspect, the vegetable oil/starch/methylcellulose emulsion is mixed in liquid or semi-solid form with a plant protein to form a meat analogue product comprising from 3 to 8 wt % vegetable oil. In an aspect, the vegetable oil/starch/methylcellulose emulsion is mixed in liquid or semi-solid form with a plant protein to form a meat analogue product comprising from 3 to 7 wt % vegetable oil. In an aspect, the vegetable oil/starch/methylcellulose emulsion is mixed in liquid or semi-solid form with a plant protein to form a meat analogue product comprising from 3 to 6 wt % vegetable oil. In an aspect, the vegetable oil/starch/methylcellulose emulsion is mixed in liquid or semi-solid form with a plant protein to form a meat analogue product comprising from 3 to 5 wt % vegetable oil. In an aspect, the vegetable oil/starch/methylcellulose emulsion is mixed in liquid or semi-solid form with a plant protein to form a meat analogue product comprising from 2 to 8 wt % vegetable oil. In an aspect, the vegetable oil/starch/methylcellulose emulsion is mixed in liquid or semi-solid form with a plant protein to form a meat analogue product comprising from 2 to 4 wt % vegetable oil. For purposes of the present discussion, the percentage of vegetable oil in the meat analogue product is based on the total weight of the meat analogue product (including oil, methylcellulose, starch, and additionally ingredients provided in liquid form or small particle form as discussed above), but not including added solid piece inclusions such as vegetables, legumes, nuts, egg and dairy products, as discussed below. Thus, the vegetable oil content is based on the “continuous phase” of the meat analogue product as described herein. Further, the vegetable oil content may include breading and coatings on the meat analogue product, but does not include oil used for frying the meat analogue product.

Any suitable mixing apparatus may be used to mix the hydrated plant protein composition with the vegetable oil/starch/methylcellulose emulsion to form the meat analogue product. The mixing apparatus used to mix the hydrated plant protein composition with the vegetable oil/starch/methylcellulose emulsion may be the same or different from the mixing apparatus used to hydrate the plant protein as discussed above.

In an aspect, the meat analogue product additionally contains added solid piece inclusions such as vegetables, legumes, nuts, egg products, dairy products and solid fat inclusions such as coconut oil. For purposes of the present discussion, “solid piece inclusions” are visibly identifiable added food ingredients provided on or distributed in the meat analogue product to enhance the organoleptic properties of the meat analogue product, such as appearance, flavor, and/or texture. In an aspect, the solid piece inclusions have at least one dimension of from about 0.5 cm to about 4 cm, or have at least one dimension of from about 0.5 cm to about 3 cm; or have at least one dimension of from about 0.5 cm to about 2 cm. In an aspect, the solid piece inclusions are selected from one or more of onion, mushroom, garlic, egg, peanuts, cashews, black beans, peppers, cheese, asparagus, cabbage, eggplant, and the like.

In an aspect, solid fat inclusions such as coconut oil pieces or flakes may be incorporated into the meat analogue product to provide a visual impression of “marbling” of the meat analogue product. Because these solid fat inclusions do not form part of the continuous phase of the meat analogue product, they do not contribute to the listed amount of vegetable oil included in the meat analogue product.

Solid piece inclusions are provided in the meat analogue product in any amount desired. In an aspect, the solid piece inclusions are provided in the meat analogue product in an amount such that the mixed vegetable oil/starch/methylcellulose emulsion/hydrated plant protein portion of the meat analogue product is the continuous phase. In an aspect, the solid piece inclusions are provided in an amount such that the mixed vegetable oil/starch/methylcellulose emulsion/hydrated plant protein portion of the meat analogue product is present in an amount sufficient to provide structural integrity of the meat analogue product so that it can be flipped during cooking without falling apart.

In an aspect, the meat analogue product is substantially free of non-meat, animal-sourced ingredients. In an aspect, the meat analogue product is substantially free of ingredients selected from the group consisting of one or more of: monosodium glutamate, artificial food coloring, added preservatives, sodium nitrite, sodium benzoate, sulfites, propyl gallate, high-fructose corn syrup, emulsifiers (other than methylcellulose or nOSA starch) and trans fat. In an aspect, the meat analogue product is substantially free of hydrocolloids selected from the group consisting of one or more of locust bean gum, carrageenan (seaweed extract), guar gum, xanthan gum, gellan gum, scleroglucan, agar, pectin, alginate, gum acacia, and gelatin. Exclusion of one or more of these ingredients from the meat analogue product is beneficial in reducing the number of additives incorporated into the product, advantageously reducing cost and also simplifying the ingredient list that must be reported to customers. It has been found to be desirable in the food industry to provide products having a reduced number of ingredients or in an aspect a “clean label” panel of ingredients where possible, which is valued by many consumers.

In an aspect, after mixing of the hydrated plant protein composition with the vegetable oil/starch/methylcellulose emulsion, an intermediate meat analogue product resembling bulk ground meat is obtained. This intermediate bulk ground meat may be packaged in a bulk form, such as a chub, for processing at a later time or for shipping to a different location for processing.

In an aspect, the intermediate meat analogue product, i.e., the mixture of hydrated plant protein composition with the vegetable oil/starch/methylcellulose emulsion, is further processed to form the meat analogue product. In an aspect, a starch or other type of binder is added to the intermediate meat analogue product to form the meat analogue product. In an aspect, the starch or binder may bind water released from the hydrated textured protein when the meat analogue product is cooked, which improves the adhesion of any coatings applied to the meat analogue product. In an aspect, the starch added to the intermediate meat analogue product is a stabilized and cross-linked waxy maize starch. In an aspect, the starch added to the intermediate meat analogue product is an acetylated distarch adipate.

The final format of the meat analogue product is configured to a desired structure suitable for use as a food product.

In an aspect, the meat analogue product is a ground meat analogue product. In an aspect, the meat analogue product is a ground meat analogue product selected from a meat patty analogue, a meatball analogue, a meatloaf analogue, and a meat sausage link analogue product. In an aspect, the meat patty analogue is a breakfast sausage analogue or a burger analogue.

In an aspect, the meat analogue product is formed by using automated patty formation equipment, automated sausage formation equipment, automated extrusion equipment, or other automated food handling equipment as are known in the food industry.

In an aspect, the meat analogue product is formulated with seasoning to provide a ground beef analogue product. In an aspect, the meat analogue product is formulated with seasoning to provide a ground pork analogue product. In an aspect, the meat analogue product is formulated with seasoning to provide a ground chicken analogue product. In an aspect, the meat analogue product is formulated with seasoning to provide a ground turkey analogue product. In this disclosure, “seasoning” can include any flavor composition.

In an aspect, the meat analogue product is a structured plant protein product comprising protein fibers that are substantially aligned to provide a whole meat muscle texture. In an aspect, the meat analogue product is a structured plant protein product formulated to mimic a meat product selected from a meat nugget analogue, a meat filet analogue, a meat portion analogue (such as a breast), and a mechanically separated meat product analogue. In an aspect, the meat analogue product is formulated to mimic a structured mechanically separated meat selected from shredded chicken, shredded pork, and shredded beef.

In an aspect, the formed meat analogue product is refrigerated or frozen for processing at a later time or for shipping to a different location for processing.

The formed meat analogue product is cooked for a suitable time and temperature to provide a cooked meat analogue product. In an aspect, the meat analogue product is cooked by baking, frying, deep frying, or grilling for a suitable time and temperature to provide a cooked meat analogue product. In an aspect, the meat analogue product is cooked in an oven at an oven temperature of from about 300° F. to about 500° F. In an aspect, the meat analogue product is cooked in an oven at an oven temperature of from about 300° F. to about 450° F. In an aspect, the meat analogue product is cooked in an oven at an oven temperature of from about 300° F. to about 375° F. In an aspect, the meat analogue product is cooked in an oven at an oven temperature of from about 350° F. to about 375° F. In an aspect, the meat analogue product is cooked in a combi oven at any of the above temperature ranges at a humidity of from about 30% to about 75%. In an aspect, the meat analogue product is cooked in a combi oven at any of the above temperature ranges at a humidity of from about 40% to about 65%. In an aspect, the meat analogue product is cooked to an internal temperature of from about 150° F. to about 180° F. In an aspect, the meat analogue product is cooked to an internal temperature of about 160° F. to about 170° F. In an aspect, the meat analogue product is cooked to an internal temperature of about 160° F. to about 205° F. In an aspect, the meat analogue product is cooked to an internal temperature of about 175° F. to about 205° F. In an aspect, the meat analogue product is cooked to an internal temperature of about 185° F. to about 205° F. In an aspect, the meat analogue product is cooked to an internal temperature of about 178° F.

In an aspect, the cooked meat analogue product is refrigerated for reheating at a later time or in a different location by a consumer.

In an aspect, the cooked meat analogue product is refrigerated for reheating at a later time or in a different location by a consumer. In an aspect, the product may be frozen using any appropriate technique. In an aspect, the product is frozen by an IQF process (“individually quick frozen”).

In an aspect, the cooked meat analogue product is provided in overwrapped trays. This package type features air permeable overwrap with meat analogue product placed on an absorbent pad in a foam or plastic tray, packaging. In an aspect, the meat analogue product is provided in a case ready tray, wherein the meat analogue product is packaged and sealed at the manufacturing facility in a plastic-lidded package. In an aspect, the cooked meat analogue product is provided in a wax-lined cardboard box. In an aspect, the cooked meat analogue product is provided in a sealed moisture vapor impermeable bag. In an aspect, the cooked meat analogue product is provided in a sealed inert gas impermeable bag. In an aspect, the cooked meat analogue product is provided in a sealed inert gas impermeable bag having a substantially oxygen-free atmosphere.

In an aspect, the customer purchasing the meat analogue product may be a home consumer. In an aspect, the customer purchasing the meat analogue product may be institutional customers, such as restaurants and food service providers (such as work or school cafeterias, hospitals, and the like). The meat analogue product may be reheated and presented essentially as provided to the customer, or may be reheated and incorporated into a final food product assembled by the customer.

In an aspect, the meat analogue product is reheated by baking, frying, deep frying, grilling or microwaving for a suitable time and temperature to provide a cooked meat analogue product.

In an aspect, the meat analogue product is used to prepare any combination final food products that one might prepare using as a ground meat product, such as burgers, meat loaf, meatballs, sausages, nuggets, meat filets, meat portions (such as a breast), shredded meat, and the like, as a component of the final food product.

### EXAMPLES

### Example 1. Soy Protein Pork Sausage Analogue Product

### A) Emulsion Preparation

An emulsion is prepared by adding 85 g liquid coconut oil and 65 g liquid canola oil, 12.5 g methylcellulose and 7 g n-octenylsuccinic anhydride modified waxy maize starch (Emcap 06376 from Cargill, Incorporated) to a bowl chopper. The ingredients are mixed in the bowl chopper on high for 3-5 minutes. Water is added to the bowl chopper, and the contents are then mixed on high for 5 minutes to form an emulsion. The emulsion is chilled to 40° F. or lower for preparation of the meat analogue product.

### B) Protein Hydration

154.6 g Textured Soy Protein (“TSP”—Prosante 10P from Cargill, Incorporated) is added to a blender with water to hydrate the TSP. The total amount of water used in this example (for both emulsion formation and textured soy hydration) is 413.4 g.

0.5 g of a savory flavor (Soy binder flavor from Givaudan SA) and 16 g salt is added, and the ingredients are mixed in the blender with vacuum for 15-20 minutes. 21 g of a hydrated soy protein (SUPRO® EX 45 from Solae) and 25 g of pork sausage seasoning are added, and the composition is mixed for 5 minutes to ensure no visual lumps are present in the hydrated protein composition.

### C. Analogue Product Formation

The emulsion is added to the hydrated protein composition in the blender, and the composition is mixed for 5-7 minutes with vacuum. The resulting Soy Protein Pork Analogue Product is hand-formed into the shape of a sausage patty of size of about 60 g., and cooked in a combi oven at 325° F., 55% humidity to an internal temperature of 165° F. The cooked soy protein pork analogue sausage patties were frozen as individual patties in an individual quick freezing (“IFQ”) process.

### D. Analogue Product Second Cook.

The cooked soy protein pork analogue sausage patties were cooked from the frozen state on a flat top grill set at 350° F. temperature setting and to an internal patty temperature of 155° F.

### Example 2. Soy Protein Pork Sausage Analogue Product

### A) Emulsion Preparation

An emulsion is prepared by adding 85 g liquid coconut oil and 65 g liquid canola oil, 12.5 g methylcellulose and 7 g n-octenylsuccinic anhydride modified waxy maize starch (PolarTex 06732 from Cargill, Incorporated) to a bowl chopper. The ingredients are mixed in the bowl chopper on high for 3-5 minutes. Water is added to the bowl chopper, and the contents are then mixed on high for 5 minutes to form an emulsion. The emulsion is chilled to 40° F. or lower for preparation of the meat analogue product.

### B) Protein Hydration

154.6 g Textured soy (“TSP”—Prosante 10P from Cargill, Incorporated) is added to a blender with water to hydrate the TSP. The total amount of water used in this example (for both emulsion formation and textured soy hydration) is 413.4 g.

0.5 g of a savory flavor (Soy binder flavor from Givaudan SA) and 16 g salt is added, and the ingredients are mixed in the blender with vacuum for 15-20 minutes. 21 g of a hydrated soy protein (SUPRO® EX 45 from Solae) and 25 g of pork sausage seasoning are added, and the composition is mixed for 5 minutes to ensure no visual lumps are present in the hydrated protein composition.

### C. Analogue Product Formation

The emulsion is added to the hydrated protein composition in the blender, and the composition is mixed for 5-7 minutes with vacuum. The resulting Soy Protein Pork Analogue Product is hand-formed into the shape of a sausage patty of size of about 60 g., and cooked in a combi oven at 325° F., 55% humidity to an internal temperature of 165° F. The cooked soy protein pork analogue sausage patties were frozen as individual patties in an individual quick freezing (“IFQ”) process.

### D. Analogue Product Second Cook.

|0085| The cooked soy protein pork analogue sausage patties were cooked from the frozen state on a flat top grill set at 350° F. temperature setting and to an internal patty temperature of 155° F.

### Example 3. Pea Protein Pork Sausage Analogue Product

### A) Emulsion Preparation

An emulsion is prepared by adding 85 g liquid coconut oil and 65 g liquid canola oil, 8 g methylcellulose and 7 g n-octenylsuccinic anhydride modified maize starch (Emcap 06376 from Cargill, Incorporated) to a bowl chopper. The ingredients are mixed in the bowl chopper on high for 3-5 minutes. Water is added to the bowl chopper, and the contents are then mixed on high for 5 minutes to form an emulsion. The emulsion is chilled to 40° F. or lower for preparation of the meat analogue product.

### B) Protein Hydration

148 g Textured pea protein (“TPP”—from Cargill, Incorporated) is added to a blender with water to hydrate the TPP. The total amount of water used in this example (for both emulsion formation and textured pea hydration) is 430 g.

0.5 g of a savory flavor (Soy binder flavor from Givaudan SA) and 16 g salt is added, and the ingredients are mixed in the blender with vacuum for 15-20 minutes. 13 g of Puris 870 Pea protein from Puris and 27.5 g of pork sausage seasoning are added, and the composition is mixed for 5 minutes to ensure no visual lumps are present in the hydrated protein composition.

### C. Analogue Product Formation

The emulsion is added to the hydrated protein composition in the blender, and the composition is mixed for 5-7 minutes with vacuum. The resulting Pea Protein Pork Analogue Product is hand-formed into the shape of a sausage patty of size of about 60 g, and cooked in a combi oven at 325° F., 55% humidity to an internal temperature of 165° F. The cooked pea protein pork analogue sausage patties were frozen as individual patties in an individual quick freezing (“IFQ”) process.

### D. Analogue Product Second Cook.

The cooked pea protein pork analogue sausage patties were cooked from the frozen state on a flat top grill set at 350° F. temperature setting and to an internal patty temperature of 155° F.

### Example 4. Pea Protein Pork Sausage Analogue Product

### A) Emulsion Preparation

An emulsion is prepared by adding 85 g liquid coconut oil and 65 g liquid canola oil, 8 g methylcellulose and 7 g n-octenylsuccinic anhydride modified maize starch (PolarTex 06732 from Cargill, Incorporated) to a bowl chopper. The ingredients are mixed in the bowl chopper on high for 3-5 minutes. Water is added to the bowl chopper, and the contents are then mixed on high for 5 minutes to form an emulsion. The emulsion is chilled to 40° F. or lower for preparation of the meat analogue product.

### B) Protein Hydration

148 g Textured Pea Protein (“TPP”—Prosante 10P from Cargill, Incorporated) is added to a blender with water to hydrate the TPP. The total amount of water used in this example (for both emulsion formation and textured pea hydration) is 430 g.

0.5 g of a savory flavor (Soy binder flavor from Givaudan SA) and 16 g salt is added, and the ingredients are mixed in the blender with vacuum for 15-20 minutes. 13 g of Puris 870 pea protein from Puris and 27.5 g of pork sausage seasoning are added, and the composition is mixed for 5 minutes to ensure no visual lumps are present in the hydrated protein composition.

### C. Analogue Product Formation

The emulsion is added to the hydrated protein composition in the blender, and the composition is mixed for 5-7 minutes with vacuum. The resulting Pea Protein Pork Analogue Product is hand-formed into the shape of a sausage patty of size of about 60 g., and cooked in a combi oven at 325° F., 55% humidity to an internal temperature of 165° F. The cooked pea protein pork analogue sausage patties were frozen as individual patties in an individual quick freezing (“IFQ”) process.

### D. Analogue Product Second Cook.

The cooked pea protein pork analogue sausage patties were cooked from the frozen state on a flat top grill set at 350° F. temperature setting and to an internal patty temperature of 155° F.

### Example 5. Pea Protein Breaded Chicken Nugget Analogue

Chicken Analogue A. Chicken Analogue A is prepared by adding 50 g liquid coconut oil and 38 g liquid sunflower oil to a bowl chopper. Methylcellulose (11 g), and n-octenylsuccinic anhydride modified maize starch (20 g, Emcap 06376 from Cargill, Incorporated) are added to the bowl chopper. The ingredients are mixed in the bowl chopper on low for 30 seconds to 1 minute. Water (157 g at <40° F.) is added to the bowl chopper, and the contents are then mixed until a white frothy gel/emulsion forms. The emulsion is then cooled to 40 F, filled into wax-lined boxes, and placed on a pallet with spacers. The pallet is then placed in the blast freezer set at −10 F for 12 hours or until all product is frozen solid. Separately, salt (5 g) are added to water (510 g) and mixed for 2 to 5 min. Textured pea protein (170 g, Puris) is then added to the aqueous mixture and mixed under vacuum (−27 mbar) for 8-10 minutes. The remaining dry ingredients (pea protein (15 g, Puris) and flavor (23 g, Givaudan)) to the hydrated textured protein and mixed for 3-5 min. The frozen emulsion is ground to max ¾ inch sized particles and augured into a blender with the hydrated textured protein/dry ingredient mixture and mixed until well incorporated. The mixture is chilled to 26-27 F and formed into nuggets, breaded (target 28-31% pickup), and par fried at 385 F for 35 seconds in expeller-pressed canola oil and cooked with partial steam to an internal temp minimum 178 F.

Chicken Analogue B. Chicken Analogue B is prepared by preparing an emulsion according to the same procedure for Chicken Analogue A above except that the coconut oil is reduced to 18 g instead of 50 g, and a stabilized and cross-linked waxy maize starch (CargillTex 06201), 15 g, is added to the hydrated textured protein along with the remaining dry ingredients (pea protein and flavor) to form the hydrated textured protein/dry ingredient mixture as described above. This resulting emulsion is further processed into a chicken analogue as described for Chicken Analogue A.

Chicken Analogue A and B test nuggets are formed to a target weight of 17 g (+/−1 g), pre-cooked, and are then battered and breaded to a range of about 22-26 g for each nugget.

Chicken Analogue B demonstrates significant improvement compared to Chicken Analogue A in coating adhesion on the test nuggets after the cook step. The cook loss for Chicken Analogue A is 6.97% while Chicken Analogue B actually demonstrated a cook gain of 0.23%.

The following additional examples proved non-limiting illustrations of the invention.

### Additional Examples

Example 1. A method of preparing a meat analogue product comprising mixing vegetable oil; a modified starch selected from a starch octenylsuccinate, a hydroxypropyl distarch phosphate, and mixtures thereof; and methylcellulose in water to form a vegetable oil/starch/methylcellulose emulsion; and mixing the vegetable oil/starch/methylcellulose emulsion in liquid or semi-solid form with a hydrated plant protein to form a meat analogue product comprising from 3 to 22 wt % vegetable oil.

Example 2. A method of providing a frozen, cooked meat analogue product comprising Cooking the meat analogue product of example 1 to provide a cooked meat analogue product; and Freezing the cooked meat analogue product to provide a frozen, cooked meat analogue product.

Example 3. A method of providing a heated, cooked meat analogue product comprising: Reheating the frozen meat analogue product of example 2 to provide a heated, cooked meat analogue product.

Example 4. The method of any one of examples 1-3, wherein the starch source of the modified starch is selected from the group consisting maize starch, potato starch, sweet potato starch, wheat starch, rice starch, tapioca starch, sorghum starch, sago starch, and mixtures thereof.

Example 5. The method of any one of examples 1-3, wherein the starch source of the modified starch is selected from the group consisting of corn starch or tapioca starch.

Example 6. The method of any one of examples 1-3, wherein the starch source of the modified starch is waxy maize starch.

Example 7. The method of any one of examples 1-6, wherein the modified starch is an n-octenylsuccinic anhydride modified starch.

Example 8. The method of any one of examples 1-6, wherein the modified starch is a hydroxypropyl distarch phosphate modified starch.

Example 9. The method of any one of examples 1-8, wherein the vegetable oil is selected from the group consisting of avocado, canola, coconut, cocoa, corn, cottonseed, flax, olive, palm, palm kernel, peanut, rapeseed, safflower, soya, and sunflower and mixtures thereof; or wherein the vegetable oil is selected from the group consisting of canola oil, coconut oil, and mixtures thereof.

Example 10. The method of any one of examples 1-9, wherein the emulsion comprises from about 1 to 12 parts modified starch for every 100 parts vegetable oil; or from about 2 to 10 parts modified starch for every 100 parts vegetable oil; or from about 2 to 8 parts modified starch for every 100 parts vegetable oil.

Example 11. The method of any one of examples 1-10, wherein the emulsion comprises from about 1 to 14 parts methylcellulose for every 100 parts vegetable oil; or from about 2 to 12 parts methylcellulose for every 100 parts vegetable oil; or from about 2 to 10 parts methylcellulose for every 100 parts vegetable oil.

Example 12. The method of any one of examples 1-11, wherein after formation of the emulsion, the emulsion is cooled to or maintained at a temperature of from about 40° F. or less; or wherein after formation of the emulsion, the emulsion is cooled to or maintained at a temperature of from about 32° F. to about 40° F.

Example 13. The method of any one of examples 1-12, wherein the meat analogue product comprises from 10 to 20 wt % vegetable oil; or wherein the meat analogue product comprises from 12 to 18 wt % vegetable oil.

Example 14. The method of any one of examples 1-13, wherein the plant protein is a protein selected from the group consisting of alfalfa, algal, barley, bean, broad bean, chia, clover, pea, chickpea, cow pea, earth pea, sweet pea, pigeon pea, kidney bean, mung bean, navy bean, soy, legume, lentil, lupin, mesquite, cocoa, carob, nut, peanut, almond, potato, gluten, cereal, maize, rice, wheat, wheat gluten, sorghum, millet, oat, rye, triticale, buckwheat, fonio, quinoa, hemp, fungal, seaweed, and mixtures thereof.

Example 15. The method of any one of examples 1-14, wherein the plant protein is selected from textured soy protein, textured pea protein, or mixtures thereof.

Example 16. The method of any one of examples 1-15, wherein the meat analogue product further comprises solid piece inclusions selected from vegetables, legumes, nuts, egg products, and dairy products.

Example 17. The method of any one of examples 1-16, wherein the meat analogue product is a ground meat analogue product selected from a meat patty analogue, a meatball analogue, a meatloaf analogue, and a meat sausage link analogue product; or wherein the meat patty analogue is a breakfast sausage analogue or a burger analogue.

Example 18. The method of any one of examples 1-17, wherein the meat analogue product is a structured plant protein product comprising protein fibers that are substantially aligned to provide a whole meat muscle texture.

Example 19. The method of any one of examples 1 or 4-20, wherein the meat analogue product is in the refrigerated state.

Example 20. The method of any one of examples 1-19, wherein the meat analogue product is substantially free of non-meat, animal-sourced ingredients.

Example 21. The method of any one of examples 1-20, wherein the meat analogue product is substantially free ingredients selected from the group consisting of one or more of monosodium glutamate, artificial food coloring, added preservatives, sodium nitrite, sodium benzoate, sulfites, propyl gallate, high-fructose corn syrup, emulsifiers (other than methylcellulose) and trans fat.

Example 22. The method of any one of examples 1-21, wherein the meat analogue product is substantially free of hydrocolloids selected from the group consisting of one or more of locust bean gum, carrageenan, guar gum, xanthan gum, gellan gum, scleroglucan, agar, pectin, alginate, gum acacia, and gelatin.

Example 23. The method of any of examples 1-22, wherein the vegetable oil is coconut oil.

Example 24. A method of preparing a meat analogue product consisting of mixing vegetable oil; a modified starch selected from a starch octenylsuccinate, a hydroxypropyl distarch phosphate, and mixtures thereof; and methylcellulose in water to form a vegetable oil/starch/methylcellulose emulsion; and mixing the vegetable oil/starch/methylcellulose emulsion in liquid or semi-solid form with a hydrated plant protein to form a meat analogue product comprising from 3 to 22 wt % vegetable oil; or from 3 to 8 wt vegetable oil.

Example 25. The method of any of examples 1-24, further comprising mixing a binder with the mixture of the vegetable oil/starch/methylcellulose emulsion and the hydrated plant protein to form the meat analogue product.

Example 26. The method of example 25, wherein the binder is a starch.

Example 27. The method of example 26, wherein the binder is a stabilized and cross-linked waxy maize starch.

Example 28. The method of any of examples 1-27, further comprising coating the meat analogue product with a coating that adheres substantially to the meat analogue product.

Example 29. The method of example 28, wherein the coating comprises a breading.

Example 30. A product made by the method of any one of the preceding examples.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of preparing a meat analogue product comprising
mixing vegetable oil; a modified starch selected from a starch octenylsuccinate, a hydroxypropyl distarch phosphate, and mixtures thereof; and methylcellulose in water to form a vegetable oil/starch/methylcellulose emulsion;
mixing the vegetable oil/starch/methylcellulose emulsion in liquid or semi-solid form with a hydrated plant protein to form a protein/emulsion mixture; and
mixing a binder with the protein/emulsion mixture to form a meat analogue product comprising from 3 to 22 wt % vegetable oil.

2. A method of providing a frozen, cooked meat analogue product comprising
cooking the meat analogue product of claim 1 to provide a cooked meat analogue product; and
freezing the cooked meat analogue product to provide a frozen, cooked meat analogue product.

3. A method of providing a heated, cooked meat analogue product comprising:
Reheating the frozen meat analogue product of claim 2 to provide a heated, cooked meat analogue product.

4. The method of claim 1, wherein the starch source of the modified starch is selected from the group consisting maize starch, potato starch, sweet potato starch, wheat starch, rice starch, tapioca starch, sorghum starch, sago starch, and mixtures thereof.

5. The method of claim 1, wherein the starch source of the modified starch is selected from the group consisting of corn starch and tapioca starch.

6. The method of claim 1, wherein the starch source of the modified starch is waxy maize starch.

7. The method of claim 1, wherein the modified starch is an n-octenylsuccinic anhydride modified starch.

8. The method of claim 1, wherein the modified starch is a hydroxypropyl distarch phosphate modified starch.

9. The method of claim 1, wherein the vegetable oil is selected from the group consisting of avocado, canola, coconut, cocoa, corn, cottonseed, flax, olive, palm, palm kernel, peanut, rapeseed, safflower, soya, and sunflower and mixtures thereof.

10. The method of claim 1, wherein the emulsion comprises from about 1 to 12 parts modified starch for every 100 parts vegetable oil.

11. The method of claim 1, wherein the emulsion comprises from about 1 to 14 parts methylcellulose for every 100 parts vegetable oil.

12. The method of claim 1, wherein after formation of the emulsion, the emulsion is cooled to or maintained at a temperature of from about 40° F. or less.

13. The method of claim 1, wherein the meat analogue product comprises from 10 to 20 wt % vegetable oil.

14. The method of claim 1, wherein the plant protein is a protein selected from the group consisting of alfalfa, algal, barley, bean, broad bean, chia, clover, pea, chickpea, cow pea, earth pea, sweet pea, pigeon pea, kidney bean, mung bean, navy bean, soy, legume, lentil, lupin, mesquite, cocoa, carob, nut, peanut, almond, potato, gluten, cereal, maize, rice, wheat, wheat gluten, sorghum, millet, oat, rye, triticale, buckwheat, fonio, quinoa, hemp, fungal, seaweed, and mixtures thereof.

15. The method of claim 1, wherein the plant protein is selected from textured soy protein, textured pea protein, or mixtures thereof.

16. The method of claim 1, wherein the meat analogue product is substantially free of non-meat, animal-sourced ingredients.

17. The method of claim 1, wherein the meat analogue product is substantially free of ingredients selected from the group consisting of one or more of monosodium glutamate, artificial food coloring, added preservatives, sodium nitrite, sodium benzoate, sulfites, propyl gallate, high-fructose corn syrup, emulsifiers (other than methylcellulose) and trans fat.

18. The method of claim 1, wherein the meat analogue product is substantially free of hydrocolloids selected from the group consisting of one or more of locust bean gum, carrageenan, guar gum, xanthan gum, gellan gum, scleroglucan, agar, pectin, alginate, gum acacia, and gelatin.

19. The method of claim 1, wherein the binder is a stabilized and cross-linked waxy maize starch.

20. A product made by the method of claim 1.
